(19) United States
(12) Patent Application Publication
(10) Pub. No.: US 2007/0101641 A1
(43) Pub. Date: May 10, 2007

(54) Method of making culture medium for agaricus blazei murill mushroom

(75) Inventor: Yong-Fang Fang, Puli Town (TW)

Correspondence Address: BIRCH STEWART KOLASCH & BIRCH, PO BOX 747, FALLS CHURCH, VA, 22040-0747, US

(73) Assignees: Yong-Fang FANG; Hsien-Chiu LIN

(21) Appl. No.: 11/269,810

(22) Filed: Nov. 9, 2005

(51) Int. Cl. C05F 17/00; C05F 3/00

(52) U.S. Cl. 47/1.1

(57) ABSTRACT

The invention relates to a method of making culture medium for Agaricus blazei Murill mushroom, which include the following steps: the sawdust is piled up to 5 to 15 meters high to undergo the first fermentation and decaying process which takes about 3 months; it is required to periodically turn over the sad dust pile every 15 to 30 days; then the dried and sterilized cattle excrements are added to the first-time fermented sawdust to undergo the second fermentation process, wherein the saw dust is piled up to 5 to 15 meters high and the internal fermentation temperature is 70 to 90 degrees centigrade; it is required to periodically turn over the sad dust pile every 15 to 30 days; finally, when the color of fermented sawdust turns dark brown, close to black, and the urine like Ammonia odor disappears, the culture medium can be used as the basic materials of bag-logs for cultivating Agaricus blazei Murill mushroom.

### BACKGROUND OF THE INVENTION

(1) Field of the Invention

The invention relates to a method of making culture medium for Agaricus blazei Murill mushroom, and more particularly to a bag-log made of the culture medium that is able to cultivate the carpophores (fruiting bodies) of Agaricus blazei Murill mushroom.

(2) Description of the Prior Art

Ever since it was imported and introduced as a commercial product, Agaricus blazei Murrill has been widely accepted by the general publics as health food. Current most products made from Agaricus blazei Murill mushroom on the market are its mycelium products and not carpophores products. The reason is that cultivating the carpophores (fruit bodies) of Agaricus blazei Murill mushroom involves the influential factors of culture medium and cultivation technology. Particularly, how to supplement proper amount of nutrient during the cultivation process is one of the critical factors that determine the success of high yield and quality control of the artificial cultivation of Agaricus blazei Murill mushroom.

The commonly used culture mediums for cultivating mushrooms include grain culture medium, straw culture medium, and sawdust culture medium. Among which, the grain culture medium is only suitable to be used as the bag-log culture medium for cultivating stock culture, whose cost is too high to be practical for cultivating Agaricus blazei Murill mushroom. The straw culture medium is only suitable to be used as the culture medium of Agaricus bisporus mushroom. Furthermore, it often contains heavy metals and, with high fiber contents, is hard to be decomposed, so it is not suitable to be used as the culture medium of edible Agaricus blazei Murill mushroom. Sawdust culture medium, although sometimes used as the culture medium of Agaricus blazei Murill mushroom, the sawdust is unprocessed so its fiber and lignin contents can not be decomposed completely and is easy to grow other strains of mushrooms. Therefore, its yield is merely around 25-30 grams of dry Agaricus blazei Murill mushroom per kilogram of sawdust.

### SUMMARY OF THE INVENTION

The primary objective of the present invention is to provide a method of making culture medium for Agaricus blazei Murill mushroom, including two compost fermentation processes to produce the nutrients required for cultivating Agaricus blazei Murill mushroom and achieve good yield.

The other object of the present invention is to provide a culture medium through special compost fermentation processes to be used for cultivating the carpophores (fruiting bodies) of Agaricus blazei Murill mushroom and achieve good harvest yield.

According to the first objective of the present invention to provide a method of making culture medium for Agaricus blazei Murill mushroom which includes the following steps: the sawdust is piled up to 5 to 15 meters high to undergo the first fermentation and decaying process which takes about 3 months; then the dried and sterilized cattle excrements are added to the fermented sawdust to undergo the second fermentation process, wherein the saw dust is piled up to 5 to 15 meters high and the internal fermentation temperature is 70 to 90 degrees centigrade; it is required to periodically turn over the sad dust pile every 15 to 30 days during these two fermentation processes and water the sawdust pile until water overflows out of the pile after each turning; finally, when the color of fermented sawdust turns dark brown, close to black, and the urine like Ammonia odor disappears, the culture medium treatment process is completed.

According to the second object of the present invention is to provide an Agaricus blazei Murill mushroom culture medium that includes 75% of decayed and fermented sawdust and 25% of sterilized cattle excrements.

The characteristics of the Agaricus blazei Murill mushroom culture medium in accordance with the first and second objectives of the present invention are listed as the followings: the cattle excrements within the medium has fibers, minerals, and vitamins that can be absorbed by the Agaricus blazei Murill mushroom and stimulate its growth, which is able to increase the harvest yield of Agaricus blazei Murill mushroom. In addition, the two-time fermentation process can reduce the harmful elements so that the cultivated Agaricus blazei Murill mushroom is not harmful to human health. Because of the previously stated characteristics, the culture medium for Agaricus blazei Murill mushroom in accordance with the present invention, compared to the prior art, not only facilitates the cultivation of Agaricus blazei Murill mushroom carpophores (fruiting bodies) and high harvest yield, but also produces meaty, crunchy, yet tender and refreshing product without harmful element.

### DESCRIPTION OF THE PREFERRED EMBODIMENT

The invention disclosed herein is directed to a method of making culture medium for Agaricus blazei Murill mushroom. In the following description, numerous details are set forth in order to provide a thorough understanding of the present invention. It will be appreciated by one skilled in the art that variations of these specific details are possible while still achieving the results of the present invention. In other instance, well-known compositions are not described in detail in order not to unnecessarily obscure the present invention.

The present invention to provide a method of making culture medium for Agaricus blazei Murill mushroom which includes the following steps: the sawdust is piled up to 5 to 15 meters high to undergo the first fermentation and degeneration process which takes about 3 months; the pile is periodically turned over; then the dried and sterilized cattle excrements are added to the fermented sawdust to undergo the second fermentation process, wherein the saw dust is piled up to 5 to 15 meters high and the internal fermentation temperature is 70 to 90 degree centigrade; it pile is periodically turn again; when the color of fermented sawdust turns dark brown, close to black, and the urine like Ammonia odor disappears, the culture medium treatment process is completed.

During the previously stated process of making the culture medium for Agaricus blazei Murill mushroom, the dried and sterilized cattle excrements are added to the fermented sawdust to undergo the second fermentation process and the sterilizing temperature of the cattle excrements is around 65 to 70 degrees centigrade. At the same time, a proper amount of lime powder or calcium carbonate is added to adjust the Ph level of the compost. The purpose of maintaining the internal temperature at around 70 to 90 degrees centigrade is to let the sawdust to be fully fermented and utilize the sterilization effect of the high temperature generated by the fermentation process to prevent the growth of other strains of mushrooms remaining in the culture medium, which may affect the growth of Agaricus blazei Murill mushroom.

During the previously stated process of making the culture medium for Agaricus blazei Murill mushroom, it is required to periodically turn over the sawdust pile every 30 days during the first and second fermentation processes, and the purpose of pile turning is to let the sawdust to be fully and evenly fermented; it is also required to water the new sawdust pile after each turning until water overflows out of the pile, which can be achieved by sticking the water hose into the sawdust pile until the water flows out.

During the previously stated process of making the culture medium for Agaricus blazei Murill mushroom, the determination of the readiness of the culture medium after the second fermentation process is based upon:

Sawdust Color

The color of not fully fermented sawdust is light brown (during the first fermentation process), while the sawdust changes from light brown to dark brown or close to black after the second fermentation and degeneration process, then it is determined that the fermentation is completed.

Sawdust Odor

Before the sawdust is fully fermented, it has the urine like Ammonia odor. But if the urine like Ammonia odor disappears during the second fermentation process, it is determined that the fermentation is completed.

During the previously stated process of making the culture medium for Agaricus blazei Murill mushroom, the sawdust pile is preferably piled up like a pyramid shape during the first or second fermentation process.

The compositions of the culture medium for Agaricus blazei Murill mushroom in accordance with the present invention include: 75% of sawdust and 25% of cattle excrements. Wherein, most of the sawdust fibers and lignin within the compositions are decomposed after the two fermentation processes and effectively absorbed by the Agaricus blazei Murill mushroom. Furthermore, the harmful elements, like phenol, chloride phenol, organic acid, etc., are reduced to minimum after the two fermentation processes, which prevent to transfer them to the Agaricus blazei Murill mushroom products and become harmful to the users. In addition, the compositions of the culture medium for Agaricus blazei Murill mushroom in accordance with the present invention include cattle excrements. Since the cattle excrements contain high levels of grass fibers, minerals, and vitamins, wherein the grass fibers can be easily absorbed by the Agaricus blazei Murill types of straw fungi and the minerals and vitamins are able to provide the required nutrients during the growth of Agaricus blazei Murill mushroom. Therefore, the harvest yield of the culture medium in accordance with the present invention is 35 to 40 grams of dry Agaricus blazei Murill mushroom carpophores (fruit bodies) per kilogram of two-time fermented sawdust, which is more than the outputs of other prior cultivation technologies.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

I claim:

1. A method of making culture medium for Agaricus blazei Murill mushroom includes the following steps:
a. pile up the sawdust up to 5 to 15 meters high to undergo the first fermentation process which takes 3 months,
b. periodically turn over the sawdust pile,
c. add dried and sterilized cattle excrements to the fermented sawdust stated in a to undergo the second fermentation process, wherein the sawdust pile is 5 to 15 meters high and the fermentation temperature is 70 to 90 degrees centigrade,
d. periodically turn over the sawdust pile,
e. the culture medium is ready when the color of fermented sawdust turns dark brown, close to black, and the urine like Ammonia odor disappears.

2. A method according to claim 1, wherein said sawdust pile is periodically turned over every 15 to 30 days.

3. A method according to claim 2, wherein said sawdust pile is watered until water flows out the pile after each periodic turning of said sawdust pile

4. A method according to claim 1, wherein the ratios between said sawdust and said cattle excrements during the second fermentation process are said sawdust 75% and said cattle excrements 25%.

5. A method according to claim 1, wherein of lime powder and calcium carbonate is added to said sawdust to adjust the Ph level during the second fermentation process.

6. A method according to claim 1, wherein said cattle excrements has gone through the sterilization process of 60 to 75 degrees centigrade.

7. A culture medium for Agaricus blazei Murill mushroom include: 75% of two-time fermented sawdust and 25% of sterilized cattle excrements.
